(19) United States
(12) Patent Application Publication
(10) Pub. No.: US 2009/0235096 A1
(43) Pub. Date: Sep. 17, 2009

(54) Network Connection Device

(75) Inventors: David Thomas, Cheshire (GB); Albert Font Aranega, Badalona (ES); Hans-Juergen Niethammer, Kirchheimbolanden (DE)

Correspondence Address: BAKER & DANIELS LLP, 300 NORTH MERIDIAN STREET, SUITE 2700, INDIANAPOLIS, IN, 46204, US

(73) Assignee: Tyco Electronics UK Ltd., Wiltshire (GB)

(21) Appl. No.: 12/084,448

(22) PCT Filed: Nov. 3, 2006
(86) PCT No.: PCT/GB2006/004108

§ 371 Date: May 1, 2008

(30) Foreign Application Priority Data
Nov. 4, 2005 (GB) 0522514.9

(51) Int. Cl. G06F 1/26

(52) U.S. Cl. 713/310

(57) ABSTRACT

An assembly for transmitting data and/or power comprises a “Power over Ethernet” (PoE) control device having a plurality of connection ports for connection thereto of one or more network connection devices. The assembly includes connected via the ports plural network connection devices that are each capable of transmitting data and/or power over a cabling network, and are each connected to the PoE control device. Each network connection device includes at least one connection thereto of cabling and/or a further device; and the assembly includes one or more PoE modules operatively connected to the PoE control device and/or the network connection device. Each connection port of the PoE control device includes a releasable connection.

This invention concerns an assembly for permitting “Power-over-Ethernet” (PoE) (also sometimes referred to as “power over LAN”) connection.

PoE is a subject of rapidly growing interest at the present time. The technology involves the provision of electrical power using Ethernet cabling such as that defining a local area network (LAN).

A typical “Category 5” data transmission cable (which is a type very commonly used in LAN cabling applications) consists of four twisted pairs of conductor wire. These are used to transmit data in the form of voltages whose maximum and minimum values are dictated by internationally agreed standards.

It is possible to use data cables of this kind for the provision of electrical power as well as data, without reducing the ability of the cables simultaneously to transmit data reliably and without crosstalk.

This is achieved primarily through the use of both active control elements and certain passive components (such as centre-tapped secondary windings of transformers forming part of the LAN) that permit the connection of power supplies to the data cables. The active and passive components limit the voltages transmitted via the cables so that they lie within the maximum and minimum values permitted under the aforesaid standards.

In some applications of PoE technology the transmission of data and electrical power occurs simultaneously using the same pairs of the cables. In other applications there is a mix of uses such that some of the pairs are used for mixed data and power transmission and others are dedicated to the transmission of either power or data.

Various devices are capable of operating at the power levels provided using PoE technology. Such devices if connected to the node of a LAN may draw operating power from the network without any need for a separate connection to mains power. Suitable devices include internet protocol (IP) telephones, charge-coupled device (CCD) cameras, sensors of alarm systems, card readers and similar apparatuses. There is even available a personal computer that operates at the power levels available from a PoE arrangement.

Also a PoE-enabled network may provide backup power to devices, such as conventional personal computers, at times when mains power is unavailable. In such applications the active devices controlling the distribution of power over the LAN in question can be arranged to send network messages to devices connected at its nodes, thereby initiating modes of operation that minimise or prioritise power consumption.

The advantages of providing power over a LAN or Ethernet are such that interest in this technology is growing rapidly. However, many buildings and other locations where network cabling is installed do not incorporate the active and passive components needed to permit the transmission of power.

The structured (i.e. built-in) cabling of a new building is nowadays intended to remain in use for 10-20 years. Therefore in the majority of applications it would be uneconomical to replace it with cabling incorporating the parts needed to provide Power over Ethernet transmission.

Even when PoE equipment forms part of a LAN it is desirable to be able to upgrade the electronic components needed on a more frequent basis than the 10-20 year life of structured LAN cabling.

Thus overall there is a need to provide LAN components that permit ready upgrading of the LAN to incorporate electronics modules and parts as desired.

According to a first aspect of the invention there is provided an assembly for transmitting data and/or power comprising a “Power over Ethernet” (PoE) control device having a plurality of connection ports for connection thereto of one or more network connection devices; one or more network connection devices, that are each capable of transmitting data and/or power over a cabling network, each connected via a said port to the PoE control device and each said network connection device including at least one connection thereto of cabling and/or a further device; and one or more PoE modules operatively connected to the PoE control device and/or the network connection device, wherein the connection between each network connection device and the PoE control device is releasable, and especially is by way of a plug and socket combination.

As used herein the term “network connection device” includes but is not limited to a patch panel or similar device.

An advantage of such an arrangement is that it readily permits the upgrading of a non-PoE LAN to permit operation as a PoE installation. This derives in turn from the ease with which the components forming part of the assembly may be manufactured as “modules” that may be readily added to and removed from the assembly, preferably but not necessarily using the plug and socket connections.

These advantages may be achieved even if the LAN cabling and the patch panel are conventional or largely conventional components. The addition of the (modular) PoE components to the LAN can occur months or even years after installation of the basic LAN elements.

To this end therefore in practical embodiments of the assembly of the invention the or each network connection device includes one or more further connections to cabling forming at least part of a network.

Preferably the or each said PoE module includes one or more items selected from:
a filter;
a combiner;
a separator;
an inductance;
a sub-band communication apparatus;
an indicator apparatus; and/or
a power management device.

An out-of-band (sub-band) communications apparatus has been developed that includes first and second data lines arranged in a differential pair. The data lines convey high speed data within a first frequency range and out of band data within a second frequency range that differs from the first frequency range. The apparatus also includes a band pass filter coupled to the first and second data lines. The filter only passes the out of band data and blocks the high speed data. The apparatus also includes a device coupled to said band pass filter and configured to at least one of transmit and receive out of band data.

Certain embodiments of such an arrangement may also include a transformer having a centre power tap for one of adding and removing power from the first and second data lines. Alternatively, the filter may include a digital signal processor and an analog to digital converter configured to convert the out of band data to a digital signal.

Certain other variants on this arrangement may also include a filter configured to pass frequencies below 100 kilohertz. Optionally, the second frequency range of the apparatus may be between 100 hertz and 100 kilohertz. Alternatively, the second frequency range of the apparatus may be between 100 hertz and 20 kilohertz.

Such apparatuses may be incorporated into or may form the operational part of the distribution matrix, the connector device and/or the PoE control device of the invention. The scope of the invention therefore embraces all arrangements including sub-band communication apparatuses as described.

Furthermore the connection device may be or include one or more visual indicators (such as but not limited to LED's and other display devices). All such combinations lie within the scope of the invention.

The invention permits PoE components, of a kind that may need to be upgraded (for example in the event of the power limits mentioned in PoE standards increasing over time), to be manufactured as conveniently insertable, modular elements of the assembly of the invention.

Conveniently at least one of the network connection devices includes defined therein a data transmission link; and a said PoE module is operatively connected to the link.

This feature allows the PoE electronics, which preferably are selected from the foregoing list, to provide e.g. power signals and commands in the structured cabling of the LAN.

In a preferred embodiment of the invention one or more of the connection ports of the PoE control device includes a socket and the assembly includes a said PoE module having operatively connected thereto a module plug including one or more pins that are insertable into one or more said sockets of the PoE control device.

The inclusion of this feature allows the PoE module to be formed integrally with a plug such that the PoE module may be easily connected to and removed from the PoE control device.

Preferably one or more said connection ports of the PoE control device includes a socket, and the or each network connection device includes operatively connected thereto a cable that terminates in a cable plug including one or more pins that are releasably insertable into one or more said sockets.

It is also advantageous, from the viewpoint of constructing the PoE module integrally with or as part of a plug, that at least one PoE module of the assembly includes a housing that is integral with or secured to a cable plug.

Such a plug may connect the network connection device and the PoE control device together by way of a cable.

Conveniently at least one of the network connection devices is or includes a patch panel. In at least some preferred embodiments of the invention a plurality of the network connection devices, and in further embodiments all of them, are patch panels. However other types of network connection device are equally possible within the scope of the invention.

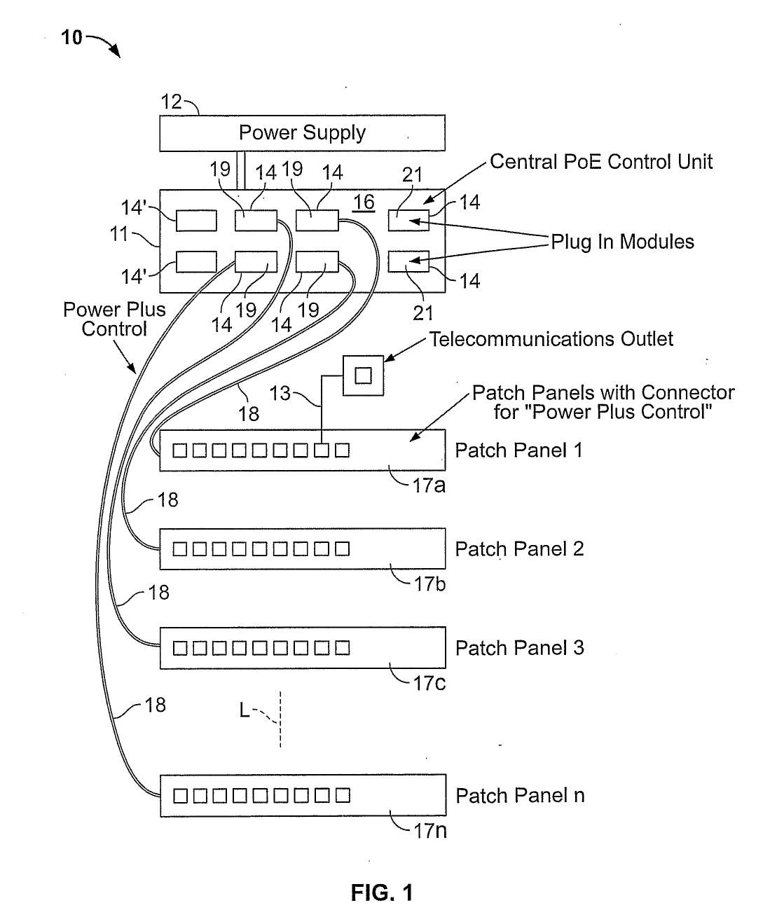

There now follows a description of a preferred embodiment of the invention, by way of non-limiting example, with reference being made to accompanying FIG. 1 which is a schematic view of an assembly in accordance with the invention, including a PoE control device, a plurality of network connection devices and one of several connector devices forming part of the assembly.

Referring to the drawing there is shown an assembly 10, according to the invention, that is useful for providing a modularly upgradeable form of PoE functionality even when the structured cabling to which the assembly is operatively connected omits PoE components.

In assembly 10 of FIG. 1 a PoE control device 11 may provide a range of per se known PoE functions including but not limited to the connection to a LAN (represented schematically by data cable 13 terminating in a network port 13a) of a power supply 12. Power supply 12 may be eg. a mains connection, a battery, or any of a range of other power sources such as solar arrays and generators.

Control device 11 may generate PoE commands and messages for transmission over the LAN. Such commands and messages include but are not limited to commands that prioritise the transmission of power over the LAN according to prevailing circumstances. The control device 11 may also provide active and/or passive control of the power voltages transmitted via the LAN.

Even though some PoE control devices are versatile there remains a need for the incorporation of other PoE elements within the LAN. In accordance with the invention the ability to add, replace (for reasons associated with eg. routine or emergency maintenance) and upgrade such elements is provided through the use of easily and installed, modular components.

To this end the control device 11 includes a plurality of connection ports 14. In the embodiment shown eight such ports are provided on a single face 16 of the PoE control device 11. In other embodiments of the invention the number and/or locations of the ports 14 may vary widely. It is expected that in the majority of practical versions of the assembly 10 such ports would be readily accessible on the exterior of the control device 11.

Each connection port 14 may have operatively connected thereto a network connection device, or a further device.

Examples of network connection devices include but are not limited to the patch panels 17a-17n shown.

The patch panels 17a-17n are in one embodiment of the invention largely conventional. In other embodiments the patch panels may be modified, for example to enhance their ability to function in a PoE-enabled LAN. The patch panels 17a-17n need not be all of the same design, and as signified by the dotted line in FIG. 1 may be connected to the control device 11 in virtually any number (as limited by the number of connection ports 14 provided).

The patch panels 17a-17n are operatively connected to the ports 14 by cables 18 that typically would be of conventional design (such as the Category 5 design of cable).

The cables 18 are each secured and operatively connected at one end to the respective patch panels 17a-17n (or other devices if present). At the other end the cables 18 are secured to the control device 11 and operatively connected thereto via the connection ports 14.

The connections at the connection ports 14 are releasable, whereby the patch panels 17a-17n or other devices may readily be connected to or disconnected from the control device 11.

In the preferred embodiment shown this is achieved through the provision of the connection ports 14 as conducting sockets into which are removably insertable respective, conducting plugs that operatively and physically terminate the cables 18. It will however be appreciated that many other reversible ways of connecting the patch panels 17a-17n or other devices to the control device 11 lie within the scope of the invention.

When as in the illustrated embodiment of the invention the patch panels are generally conventional the incorporation of PoE components may be achieved by providing such components within the housings of the plugs 19 that are insertable into the sockets defining the connection ports 14. In this case the plugs are referred to herein as “module plugs” 19.

Thus each housing of a module plug 19 may include within its interior an electronics section that is operatively connected to a cable 18 and is operatively connectable to the control device (on plugging of the module plug 19 into a socket defining one of the connection ports 14).

The electronics section may include one or more of e.g.:
a filter;
a combiner;
a separator;
an inductance;
a sub-band communication apparatus;
an indicator apparatus; and/or
a power management device the functions of which will be understood by those of skill in the PoE art.

In another arrangement of the invention the PoE modules may be omitted from the housings of the plugs. In that case the plugs herein termed “cable plugs” would terminate the cables 18 in a conventional manner.

Also in such an embodiment the electronics sections of the PoE modules could be connected to the link portions of the patch panels 17a-17n. This could be achieved eg. by hard wiring the modules to the links, but more usefully could arise from features of the patch panels permitting the releasable plugging-in and removal of PoE modules.

FIG. 1 shows removably connected via two of the connection ports 14 a pair of modified module plugs 21. These plugs do not terminate any cables and instead serve the function of permitting the connection of extra PoE electronics sections to the control device 11. Such module plugs 21 are useful for example when it is desired to upgrade the device 11, or eg. carry out diagnostic checks on the PoE components or the LAN.

Also visible in FIG. 1 is a pair of unused connection ports 14′ that are available for the connection of further module plugs 19, modified module plugs 21, cable plugs or other, modular devices. Any of these devices may, in accordance with a variant of the invention, be capable of being connected to a plural number of the ports 14 simultaneously. This may be achieved through providing the modular device in question with a plurality of connection pins, as compared with the single pin that might otherwise be provided. However other means of connecting the modular devices will occur to the worker of skill, such means including providing the modular devices each with one or more sockets that are engageable with pins protruding from the PoE control device 11. Such an arrangement of course may be made to permit simultaneous connection of the modular device(s) to multiple ports 14.

Overall therefore the assembly of the invention provides very great versatility when constructing, upgrading, repairing, maintaining or testing a PoE LAN, as a result of the use of modular PoE components.

In a refinement of the assembly 10 of the invention one or more of the network connection devices 17a-17n may include operatively secured thereto a patch cable, in a per se known manner.

1. An assembly for transmitting data and/or power comprising a “Power over Ethernet” (PoE) control device having a plurality of connection ports for connection thereto of one or more network connection devices; one or more network connection devices, that are each capable of transmitting data and/or power over a cabling network, each connected via a said port to the PoE control device and each said network connection device including at least one connection thereto of cabling and/or a further device; and one or more PoE modules operatively connected to the PoE control device and/or the network connection device, wherein the connection between each network connection device and the PoE control device is releasable.

2. An assembly according to claim 1, wherein the connection between each network connection device and the PoE control device is by way of a releasable plug and socket connection.

3. An assembly according to claim 1, wherein the or each network connection device includes one or more further connections to cabling forming at least part of a network.

4. An assembly according to claim 1, wherein the or each said PoE module includes one or more items selected from:
a filter;
a combiner;
a separator;
an inductance;
a sub-band communication apparatus; and
an indicator apparatus; and/or
a power management device.

5. An assembly according to claim 1, wherein at least one of the network connection devices includes defined therein a data transmission link; and wherein a said PoE module is operatively connected to the link.

6. An assembly according to claim 1, wherein one or more said connection ports of the PoE control device includes a socket and the assembly includes a said PoE module having operatively connected thereto a module plug including one or more pins that are insertable into one or more said sockets of the PoE control device.

7. An assembly according to claim 1, wherein one or more said connection ports of the PoE control device includes a socket, the or each network connection device including operatively connected thereto a cable that terminates in a cable plug including one or more pins that are releasably insertable into one or more said sockets.

8. An assembly according to claim 1, wherein at least one PoE module of which includes a housing that is integral with or secured to a said cable plug.

9. An assembly according to claim 1, wherein at least one of the network connection devices is or includes a patch panel.

10. A Local Area Network (LAN), comprising an assembly operatively connected thereto, the assembly comprised of a “Power over Ethernet” (PoE) control device having a plurality of connection ports for connection thereto of one or more network connection devices; one or more network connection devices, that are each capable of transmitting data and/or power over a cabling network, each connected via a said port to the PoE control device and each said network connection device including at least one connection thereto of cabling and/or a further device; and one or more PoE modules operatively connected to the PoE control device and/or the network connection device, wherein the connection between each network connection device and the PoE control device is releasable.
